(19) United States
(12) Patent Application Publication
(10) Pub. No.: US 2019/0118464 A1
(43) Pub. Date: Apr. 25, 2019

(54) THREE-DIMENSIONAL PRINTER AND A THREE-DIMENSIONAL PRINTING MODULE THEREOF

(71) Applicants: XYZPRINTING, INC., New Taipei City (TW); KINPO ELECTRONICS, INC., New Taipei City (TW); CAL-COMP ELECTRONICS & COMMUNICATIONS COMPANY LIMITED, New Taipei City (TW)

(72) Inventors: Peng-Yang CHEN, New Taipei City (TW); Wen-Ten LIN, New Taipei City (TW)

(21) Appl. No.: 16/228,376

(22) Filed: Dec. 20, 2018

Related U.S. Application Data
(63) Continuation of application No. 14/559,863, filed on Dec. 3, 2014, now abandoned.

(30) Foreign Application Priority Data
Apr. 24, 2014 (TW) 103114857

(51) Int. Cl. B29C 64/20; B29C 64/124

(52) U.S. Cl. CPC B29C 64/20; B29L 2009/00; B29C 64/124

(57) ABSTRACT

A three-dimensional printing module includes a base seat, a sintering mechanism, a coloring mechanism and a forming mechanism. The base seat is movable relative to a powder layer. The sintering mechanism is mounted to the base seat for selectively sintering the powder layer to form a sintered layer. The coloring mechanism is mounted to the base seat, and is movable in a second direction relative to the base seat for selectively coloring the sintered layer to form a sintered and colored layer. The forming mechanism is mounted to the base seat for flattening the sintered and colored layer to form a solid layer.

### CROSS-REFERENCE TO RELATED APPLICATION

This application is a continuation application (CA) of co-pending U.S. patent application Ser. No. 14/559,863, filed on Dec. 3, 2014, which claims priority of Taiwanese Application No. 103114857, filed on Apr. 24, 2014.

### BACKGROUND OF THE INVENTION

### 1. Field of the Invention

The invention relates to a three-dimensional printer, more particularly to a multi-color three-dimensional printer.

### 2. Description of the Related Art

Recently, since three-dimensional rapid prototyping (three-dimensional printing) techniques become more and more mature, they are applied in extensive fields, and have a considerable business value.

Among conventional three-dimensional rapid prototyping machines, three-dimensional printers that utilize selective heat sintering (SHS) technology are suitable for rapid prototyping of thermoplastic powder, such as polylactic acid (PLA) or acrylonitrile butadiene styrene (ABS), and are preferred by consumers.

In selective heat sintering technology, a thermoplastic powder layer is first laid. Then the thermoplastic powder layer is selectively sintered to form a solid model of one of a series of successive cross-sections of a three-dimensional CAD (computer aided design) model. By performing the laying and sintering operations of thermoplastic powder layers repeatedly, a solid model of the three-dimensional CAD model is formed.

However, a solid model made by a conventional three-dimensional printer that utilizes selective heat sintering technology is monochromic and has a color the same to that of the thermoplastic powder. To make a multi-color solid model, dyes having different colors are applied on the solid model after the sintered solid model is cooled down, or thermoplastic powders having different colors are used to form the thermoplastic powder layers. However, it is difficult to control precisely boundaries of the regions to be colored when applying dyes to the whole solid model of the CAD model, and the cooled-down solid model is inferior to absorb the dyes. Moreover, to lay thermoplastic powders having different colors to form a colored powder layer, the structure of a laying mechanism of the conventional three-dimensional printer must be more complicated.

### SUMMARY OF THE INVENTION

Therefore, one object of the present invention is to provide a three-dimensional printing module that can overcome the aforesaid drawbacks associated with the prior arts.

Accordingly, one type of a three-dimensional printing module of the present invention is adapted to be disposed on a machine body of a three-dimensional printer. The three-dimensional printer permits a powder layer to be fed thereon. The three-dimensional printing module includes a base seat, a sintering mechanism, a coloring mechanism and a forming mechanism. The base seat is adapted to be movable in a first direction relative to the powder layer. The sintering mechanism is mounted to the base seat and is adapted to selectively sinter the powder layer to form a sintered layer. The coloring mechanism is mounted to the base seat, is movable in a second direction relative to the base seat, and is adapted to selectively color the sintered layer to forma sintered and colored layer. The forming mechanism is mounted to the base seat and is adapted to flatten the sintered and colored layer to form a solid layer.

Another object of the present invention is to provide a three-dimensional printer that can overcome the aforesaid drawbacks associated with the prior arts.

Accordingly, one type of a three-dimensional printer of the present invention includes a machine body, a working table, a three-dimensional printing module and a driving module. The machine body is formed with a working space that has an upper end opening. The working table is disposed in the working space, is movable relative to the machine body in a vertical direction, and is adapted to be fed with a powder layer that is adjacent to the upper end opening of the working space. The three-dimensional printing module includes a base seat, a sintering mechanism, a coloring mechanism and a forming mechanism. The base seat is disposed on the machine body and is movable in a horizontal first direction relative to the powder layer. The sintering mechanism is mounted to the base seat, and is adapted to selectively sinter the powder layer to form a sintered layer. The coloring mechanism is mounted to the base seat, is movable in a horizontal second direction relative to the base seat, and is adapted to selectively color the sintered layer to form a sintered and colored layer. The forming mechanism is mounted to the base seat, and is adapted to flatten the sintered and colored layer to form a solid layer. The driving module drives the base seat of the three-dimensional printing module to move in the first direction.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of a first preferred embodiment of a three-dimensional printer according to the invention;

FIG. 2 is a perspective view of a three-dimensional printing module of the first preferred embodiment;

FIG. 3 is a fragmentary schematic side view illustrating a feeding mechanism of the first preferred embodiment feeding a powder layer;

FIG. 4 is another fragmentary schematic side view of the first preferred embodiment illustrating the three-dimensional printing module selectively sintering the powder layer;

FIG. 5 is another fragmentary schematic side view of the first preferred embodiment illustrating the feeding mechanism feeding another powder layer above the sintered powder layer;

FIG. 6 is a perspective view of a three-dimensional printing module of a second preferred embodiment of a three-dimensional printer according to the invention;

FIG. 7 is a perspective view of a three-dimensional printing module of a third preferred embodiment of a three-dimensional printer according to the invention; and

FIG. 8 is a cutaway side view of a three-dimensional printing module of a fourth preferred embodiment of a three-dimensional printer according to the invention.

### DETAILED DESCRIPTION OF THE PREFERRED EMBODIMENTS

Before the present invention is described in greater detail, it should be noted that like elements are denoted by the same reference numerals throughout the disclosure.

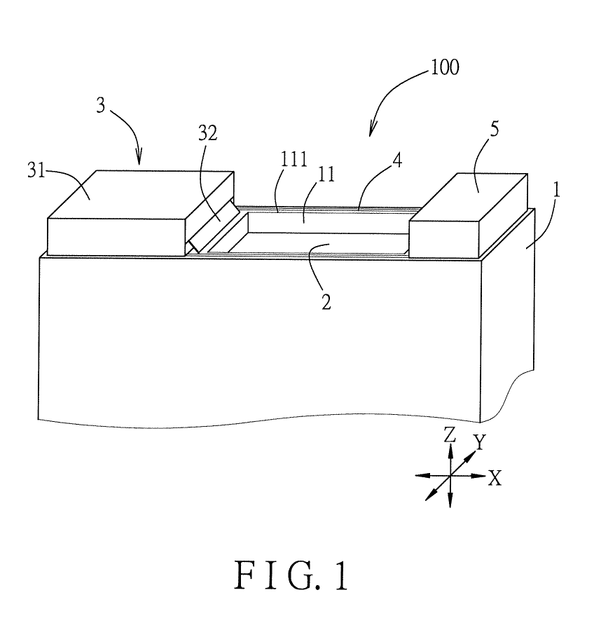

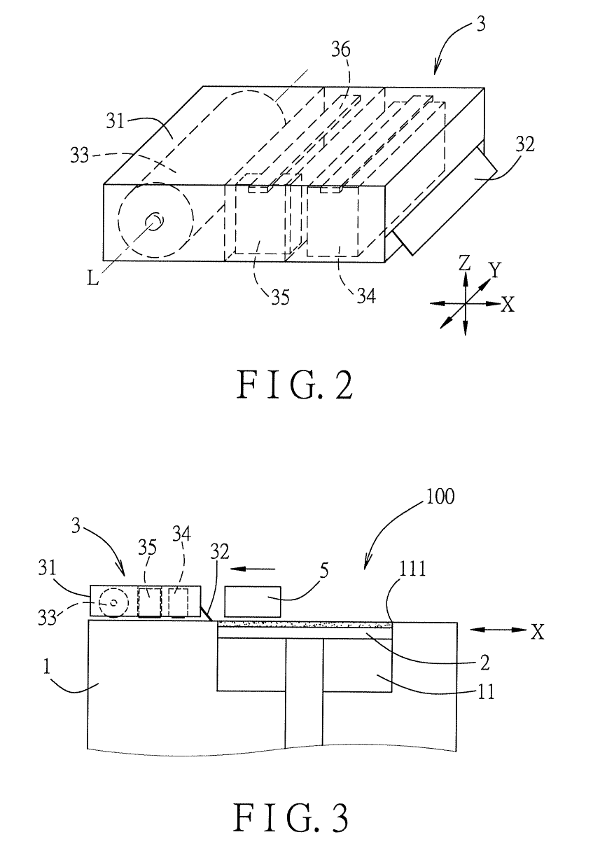

As shown in FIGS. 1 and 2, a first preferred embodiment of a three-dimensional printer 100 according to the present invention includes a machine body 1, a working table 2, a three-dimensional printing module 3, a driving module 4 and a feeding module 5. The machine body 1 is formed with a working space 11 that has an upper end opening 111. The working table 2 is disposed in the working space 11, and is movable relative to the machine body 1 in a vertical direction (Z). The feeding module 5 is disposed on the machine body 1, and is movable relative to the machine body 1 in a horizontal first direction (X) to pass past the upper end opening 111 of the working space 11 to feed a powder layer on the working table 2. The three-dimensional printing module 3 includes a base seat 31 that is disposed on the machine body 1, and that is movable relative to the machine body 1 in the first direction (X) to pass past the upper end opening 111 of the working space 11. The driving module 4 is disposed on the machine body 1 for driving movements of the feeding module 5 and the base seat 31 of the three-dimensional printing module 3.

The three-dimensional printing module 3 further includes a scrape mechanism 32, a forming mechanism 33, a sintering mechanism 34, a coloring mechanism 35 and a driving mechanism 36.

The scrape mechanism 32 is mounted to an outer surface of the base seat 31. In this embodiment, the scrape mechanism 32 is configured as a scraper blade that is driven by the base seat 31 to scrape the powder layer fed on the working table 2 when the base seat 31 moves in the first direction (X).

The forming mechanism. 33 is mounted on the base seat 31, and is spaced apart from the scrape mechanism 32 in the first direction (X). In this embodiment, the forming mechanism 33 is configured as a roller that is mounted rotatably on the base seat 31 and that has a rotating axis (L) extending in a horizontal second direction (Y) perpendicular to the first direction (X). The length of the roller 33 is substantially equal to the width of the upper end opening 111 of the working space 11 in the second direction (Y).

The sintering mechanism 34 is mounted on the base seat 31, and is disposed between the scrape mechanism 32 and the forming mechanism 33. In this embodiment, the sintering mechanism is configured as a thermal print head (TPH).

The coloring mechanism 35 is mounted on the base seat 31, and is disposed between the sintering mechanism 34 and the forming mechanism 33. In this embodiment, the coloring mechanism 35 is configured as an inkjet print head assembly that contains dyes having different colors and that is movable relative to the base seat 31 in the second direction (Y).

The driving mechanism. 36 is mounted to the base seat 31 for driving the coloring mechanism 35 to move in the second direction (Y). In this embodiment, the driving mechanism 36 includes guide rails and servomotors (not shown) that are mounted to the base seat 31, but is not limited to such a structure.

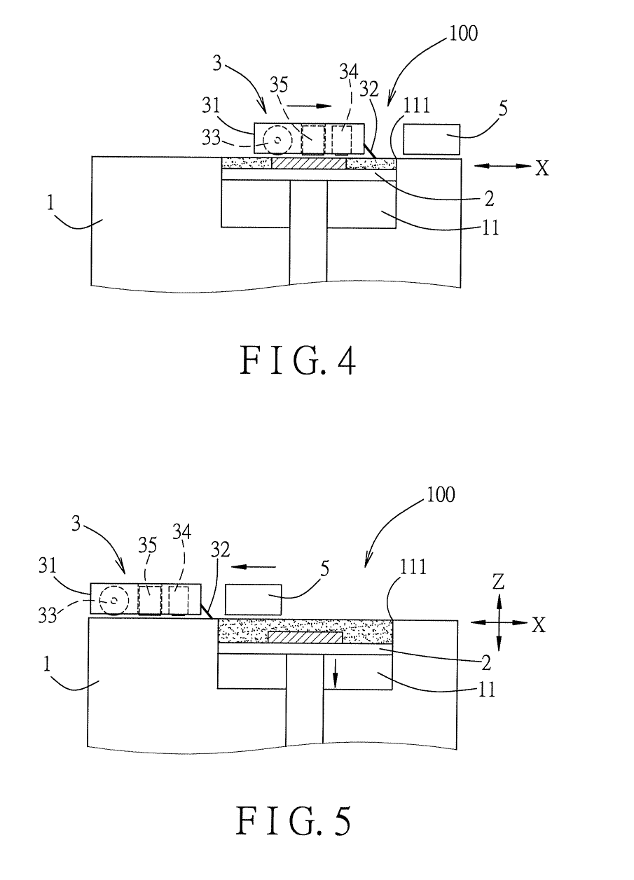

FIGS. 3 and 4 illustrate operation of the first preferred embodiment of the three-dimensional printer 100, wherein the working table 52 is initially disposed adjacent to the upper end opening 111 of the working space 11. The driving module 4 (see FIG. 1) first drives the feeding module 5 to move in the first direction (X) to feed a powder layer on the working table 52. Then, the driving module 4 drives the base seat 31 of the three-dimensional printing module 3 to move relative to the powder layer in the first direction (X) to deal with the powder layer. During the movement of the base seat 31, the scrape mechanism 32 scrapes an upper portion of the powder layer such that the powder layer has a uniform thickness and is suitable for being sintered, the sintering mechanism 34 selectively sinters the powder layer to form a sintered layer that is in a molten state, the coloring mechanism 35 is driven by the driving mechanism 35 to move reciprocally in the second direction (Y) relative to the base seat 31 to apply the dyes having different colors onto the sintered layer to form a sintered and colored layer, and the forming mechanism 33 rolls the sintered and colored layer to flatten and cool the sintered and colored layer down to form a finished layer that includes un-sintered powder and a colored solid model of a first one of a series of successive cross-sections of a three-dimensional CAD model.

Referring to FIG. 5, after the solid model of the first cross-section of the CAD model is formed, the working table 2 is lowered relative to the machine body 1. Afterward, the driving module 4 drives the feeding module 5 to feed another powder layer on the finished layer, and then drives the base seat 31 to move relative to the powder layer, such that the three-dimensional printing module 3 forms another finished layer on the previous finished layer. By performing the abovementioned operations repeatedly, a colored solid model of the CAD model is obtained.

The first preferred embodiment of the three-dimensional printer 100 of this invention applies dyes to a sintered monochromic powder layer to form a colored solid model. It is noted that the molten-state sintered layer is superior to absorb the dyes, so that the quality of the coloration of the first preferred embodiment is better than the conventional three-dimensional printer that applies dyes to a cooled-down sintered solid model.

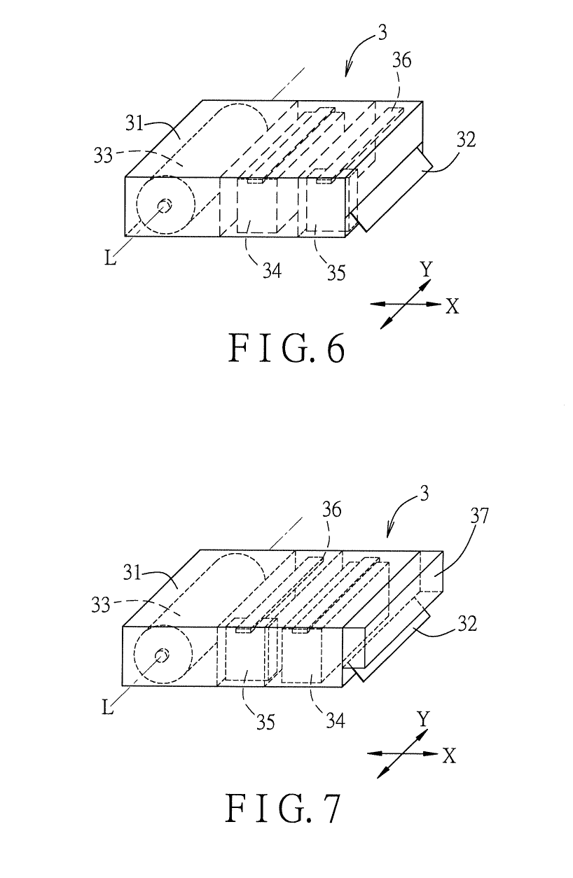

Referring to FIG. 6, a three-dimensional printing module 3 of a second preferred embodiment of the three-dimensional printer 100 according to the present invention is similar to that of the first preferred embodiment. What is different is that the coloring mechanism 35 of the three-dimensional printing module of the second preferred embodiment is disposed between the scrape mechanism 32 and the sintering mechanism 34 to directly apply dyes to the powder layer. The quality of the coloration of the second preferred embodiment is also better than the conventional three-dimensional printer that applies dyes to a cooled-down sintered solid model.

Referring to FIG. 7, a three-dimensional printing module 3 of a third preferred embodiment of the three-dimensional printer 100 according to the present invention is similar to that of the first preferred embodiment. The difference between the first and third preferred embodiments is that the three-dimensional printing module 3 of the third preferred embodiment further includes a feeding mechanism 37 mounted on the base seat 31 and disposed at one side of the scrape mechanism 32 opposite to the sintering mechanism. 34 for feeding a powder layer on the working table 2 during the movement of the base seat 31 driven by the driving module 4. With such a configuration, the feeding module 5 of the third preferred embodiment can be omitted. Therefore, the three-dimensional printer 100 of the third preferred embodiment has a smaller dimension and a simplified structure.

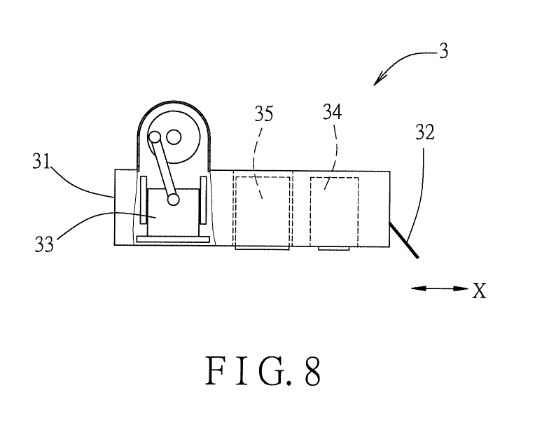

Referring to FIG. 8 a three-dimensional printing module 3 of a fourth preferred embodiment of the three-dimensional printer 100 according to the present invention is similar to that of the first preferred embodiment. The difference between the first and fourth preferred embodiments is that the forming mechanism 33 of the three-dimensional printing module 3 of the third preferred embodiment is configured as a pressing cuboid that is movable relative to the base seat 31. The pressing cuboid is operable to press against the sintered and colored layer to flatten the sintered and colored layer to form the finished layer.

To sum up, the three-dimensional printer 100 of this invention applies dyes to a monochromic powder layer or a sintered monochromic powder layer to forma colored solid model, such that the quality of the coloration of this invention is better than the conventional three-dimensional printer that applies dyes to a cooled-down sintered solid model. Moreover, the feeding module 5 or the feeding mechanism 37 has a structure simpler than that of the conventional three-dimensional printer that feeds thermoplastic powders having different colors to form a colored powder layer.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for forming a colored solid model, comprising steps of:
a) providing a powder layer;
b) sintering a selective portion of the powder layer to form a sintered layer; and
c) coloring selective portion of the sintered layer to form a colored sintered layer.

2. The method as claimed in claim 1, further comprising, after step c), a step of flattening the colored sintered layer.

3. The method as claimed in claim 1, further comprising, between steps a) and b), a step of scraping the powder layer so that the powder layer has a uniform thickness.

4. A method for forming a solid model corresponding to a computer aided design (CAD) model, comprising steps of:
a) dividing the CAD model into a plurality of successive layers;
b) providing a powder layer;
c) sintering a selective portion of the powder layer to form a solid model corresponding to a first one of the layers of the CAD model;
d) coloring a selective portion of the solid model formed in step c) to form a colored solid model corresponding to the first one of the layers of the CAD model;
e) providing a powder layer on the colored solid model formed in step d);
f) sintering a selective portion of the powder layer provided in step e) to form a solid model corresponding to a next one of the layers of the CAD model;
g) coloring a selective portion of the solid model formed in step f) to form a colored solid model corresponding to the next one of the layers of the CAD model; and
h) repeating steps e) to g) to form colored solid models corresponding to remaining one(s) of the layers of the CAD model, where in executing step e), the colored solid model formed in step g) is to replace the colored solid model formed in step d).

5. The method as claimed in claim 4, further comprising, after each of step d) and step g), a step of flattening the colored solid model thus formed.

6. The method as claimed in claim 4, further comprising, after each of step b) and step e), a step of scraping the powder layer thus provided so that the powder layer has a uniform thickness.

7. A method for forming a solid model corresponding to a CAD model by a three-dimensional printer, the three-dimensional printer including a machine body, a working table that is movable relative to the machine body in a vertical direction, a feeding mechanism, a base seat that is disposed on the machine body and that is movable in a first direction, a sintering mechanism that is mounted to the base seat, and a coloring mechanism that is movably mounted to the base seat, the method comprising steps of:
a) dividing the CAD model into a plurality of successive layers;
b) providing, by the feeding mechanism, a powder layer;
c) sintering, by the sintering mechanism, a selective portion of the powder layer to form a solid model corresponding to a first one of the layers of the CAD model;
d) coloring, by the coloring mechanism, a selective portion of the solid model formed in step c) to form a colored solid model corresponding to the first one of the layers of the CAD model;
e) providing, by the feeding mechanism, a powder layer on the colored solid model formed in step d);
f) sintering, by the sintering mechanism, a selective portion of the powder layer provided in step e) to form a solid model corresponding to a next one of the layers of the CAD model;
g) coloring, by the coloring mechanism, a selective portion of the solid model formed in step f) to form a colored solid model corresponding to the next one of the layers of the CAD model; and
h) repeating steps e) to g) to form colored solid models corresponding to remaining one(s) of the layers of the CAD model, where in executing step e), the colored solid model formed in step g) is to replace the colored solid model formed in step d).

8. The method as claimed in claim 7, the three-dimensional printer further including a forming mechanism that is mounted to the base seat, the method further comprising, after each of step d) and step g), a step of flattening, by the forming mechanism, the colored solid model thus formed.

9. The method as claimed in claim 7, the three-dimensional printer further including a scrape mechanism that is mounted to the base seat, the method further comprising, after each of step b) and step e), a step of scraping, by the scrape mechanism, the powder layer thus provided so that the powder layer has a uniform thickness.
